(19) United States
(12) Patent Application Publication
(10) Pub. No.: US 2008/0094045 A1
(43) Pub. Date: Apr. 24, 2008

(54) VOLTAGE REGULATOR WITH OUTPUT ACCELERATED RECOVERY CIRCUIT

(75) Inventor: Chung-Wei Lin, Taipei City (TW)

Correspondence Address: WPAT, PC, 7225 BEVERLY ST., ANNANDALE, VA, 22003, US

(73) Assignee: HOLTEK SEMICONDUCTOR INC., Hsinchu (TW)

(21) Appl. No.: 11/854,105

(22) Filed: Sep. 12, 2007

(30) Foreign Application Priority Data
Oct. 20, 2006 (TW) 095138671

(51) Int. Cl. G05F 1/00

(52) U.S. Cl. 323/274

(57) ABSTRACT

A voltage regulator with output accelerated recovery circuit is disclosed, which is substantially a low dropout voltage regulator (LDO) having a comparator and a pull-down transistor, both being connected between the positive feedback input node of its operational amplifier (OP) and the ground end thereof. In a preferred aspect, the comparator is used for detecting the voltage variation of a reference node, whereas the reference node is defined to be a node located between a first feedback resistor and a second feedback resistor. Operationally, as the voltage detected at the reference node is larger than a predetermined voltage, the pull-down transistor is forced to turn on so as to sink the output voltage rapidly for returning the same back into regulation.

### FIELD OF THE INVENTION

The present invention relates to a voltage regulator with output accelerated recovery circuit, and more particularly, to an improved voltage regulator achieved by configuring additionally a comparator and a pull-down transistor into a conventional low dropout voltage regulator (LDO), both being connected between the positive feedback input node of its operational amplifier (OP) and the ground end thereof. In a preferred aspect, the comparator is used for detecting the voltage variation of a reference node, whereas the reference node is defined to be a node located between a first feedback resistor and a second feedback resistor so that the voltage of the positive feedback input node can be detected thereby. Operationally, as the voltage detected at the reference node is larger than a predetermined voltage, the pull-down transistor, being preferably an N-MOSFET, is forced to turn on so as to sink the output voltage (Vₒᵤₜ) rapidly for returning the same back into regulation.

### BACKGROUND OF THE INVENTION

A voltage regulator is an electrical regulator designed to automatically maintain a constant voltage level. Please refer to FIG. 1, which is a schematic circuit diagram of a prior-art low dropout voltage regulator. When the output current of the prior-art low dropout (LDO) voltage regulator of FIG. 1 is changed rapidly, transient output voltages are induced at the regulator output. Usually the operational amplifier OP1 of the regulator can compensate for these transients and the output voltage can quickly recover before the transient voltages create problems in the system. However, in the case when a very large current load is rapidly removed from a regulator (for example: five hundreds of milliamps to zero amp), the output voltage can rise to dangerously high levels and remain high for a long period of time before returning to regulation. This high output voltage condition results when the output load current changes more rapidly than the amplifier can respond. For the period of time between the removal of the output current load and the appropriate response of the amplifier OP1 (the response time), the output voltage loses regulation, while the gate of the output PMOSFET (P-channel metal oxide semiconductor field effect transistor), MP_{O}, is still being held at a voltage level that can supply large currents to the load, but the load has been removed. The current that was previously going to the load begins charging the output capacitor Cₒᵤₜ, during the response time, and forces the output voltage to rise. Once the amplifier OP1 has correctly responded to the change of the load current, the output voltage of the amplifier OP1 is high enough to cut-off the output PMOS, MP_{O}. With the output PMOS cut-off and the load current removed, the only current path available to discharge the high output voltage on Cₒᵤₜ is through the feedback resistors, R_{fb1} and R_{fb2}. These resistors are usually resistors having high resistance (to minimize the quiescent current of the regulator), and are only able to sink a few microamps of current. With only the resistor current available to discharge the output capacitor, it can take hundreds of milliseconds for the regulator to return to regulation.

Another prior-art voltage regulator is a low dropout voltage regulator disclosed in U.S. Pat. No. 5,864,227. It is capable of improving the recovery time of the aforesaid prior-art voltage regulator by designing a circuit therein for acquiring the comparison of a reference voltage V_{g} and a predefined voltage. That means, when V_{g} is larger than the predefined voltage, the PMOS, MP_{O}, is then forced to turn on and thus the output voltage Vₒᵤₜ can be sink rapidly for returning the same back into regulation. However, the reference voltage V_{g} can not reflect the variation of the Vₒᵤₜ rapidly enough. Therefore, as the Vₒᵤₜ is raised, the reference voltage V_{g} will not change until the amplifier OP1 has correctly responded to the rise of the Vₒᵤₜ. As a result, the voltage regulator disclosed in U.S. Pat. No. 5,864,227 is still not effective enough. In addition, as the pull-down transistor used in the aforesaid voltage regulator is a P-MOSFET device that it is short of discharge efficiency since it is driven by a comparatively smaller current, the duration of returning the regulator back to regulation is still requiring to be improved.

### SUMMARY OF THE INVENTION

In view of the disadvantages of prior art, the primary object of the present invention is to provide an improved voltage regulator achieved by configuring additionally a comparator and a pull-down transistor into a low dropout voltage regulator (LDO), both being connected between the positive feedback input node of its operational amplifier (OP) and the ground end thereof; wherein the comparator is used for detecting the voltage variation of a reference node while the reference node is defined to be a node located between a first feedback resistor and a second feedback resistor so that the voltage of the positive feedback input node can be detected thereby; and the pull-down transistor is forced to turn on so as to sink the output voltage (Vₒᵤₜ) rapidly for returning the same back into regulation as the voltage detected at the reference node is larger than a predetermined voltage.

Preferably, the pull-down transistor is substantially an N-channel metal oxide semiconductor field effect transistor (N-MOSFET).

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic circuit diagram of a prior-art low dropout voltage regulator.

FIG. 2 is a schematic circuit diagram of a low dropout voltage regulator according to an exemplary embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

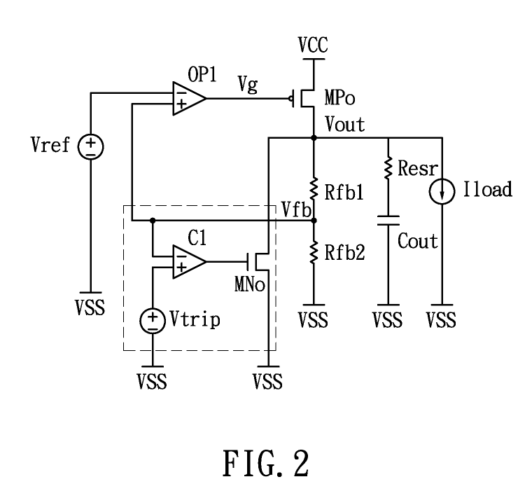

Please refer to FIG. 2, which is a schematic circuit diagram of a low dropout voltage regulator according to an exemplary embodiment of the invention. The voltage regulator of FIG. 2 comprises: an operational amplifier OP1, a comparator Cl, an output transistor MP_{O}, a pull-down transistor MN_{O}, an output capacitor Cₒᵤₜ, a first feedback resistor R_{fb1}, a second feedback resistor R_{fb2}, and a resistor Rₑₛᵣ, being the equivalent series resistor of the output capacitor Cₒᵤₜ. A source voltage V_{CC}, a reference voltage V_{ref}, and a biased voltage Vₜᵣᵢₚ are supplied to the voltage regulator. An output load current I_{load}, a gate voltage V_{g}, an output voltage Vₒᵤₜ, and a feedback voltage V_{fb} are therefore generated in the voltage regulator. The operational amplifier is configured for receiving the feedback voltage V_{fb} at its positive feedback node and the feedback voltage is designed for reflecting the variation of the output voltage. The comparator, electrically connected to the operational amplifier, is for comparing the feedback voltage V_{fb} with the biased voltage Vₜᵣᵢₚ. The pull-down transistor MN_{O} electrically connected between the comparator and the ground end is for sinking the output voltage Vₒᵤₜ rapidly for returning the same back into regulation.

By which, as the output load current of the aforesaid voltage regulator is changed rapidly, the operational amplifier OP1 can compensate for these transients in time and the output voltage can quickly recover while the current that was previously going to the PMOS, is diverted to charge the output capacitor Cₒᵤₜ so as to force the output voltage to rise. Once the amplifier OP1 has correctly responded to the change in the load current and the output capacitor Cₒᵤₜ has been charged, the output voltage Vₒᵤₜ of the amplifier OP1 is high enough to cut-off the output PMOS, i.e. MP_{O}. With the output PMOS cut-off and the load current removed, the only current path available to discharge the high output voltage on Cₒᵤₜ is through the feedback resistors, R_{fb1} and R_{fb2} .

It is noted that the comparator Cl is capable of comparing the feedback voltage V_{fb} and the biased voltage Vₜᵣᵢₚ so as to force the pull-down transistor MN_{O} to turn on and thus sink the output voltage Vₒᵤₜ rapidly for returning the same back into regulation.

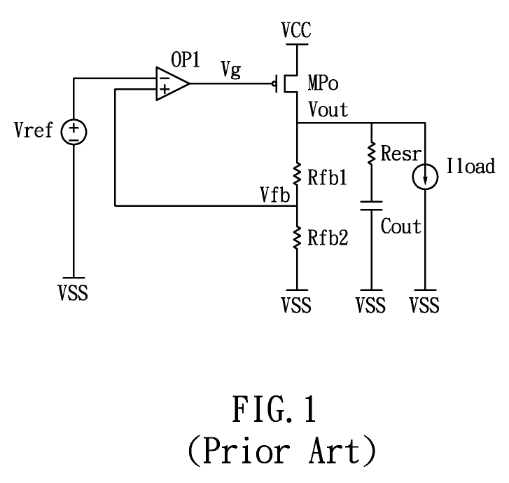

In addition to the circuitry shown in FIG. 1, an additional circuit comprising a comparator C1 and a pull-down transistor MN_{O}, enclosed by the dotted frame of FIG. 2, is configured in the voltage regulator of FIG. 2. As the comparator C1 is capable of comparing the feedback voltage V_{fb} and the biased voltage Vₜᵣᵢₚ so as to detect the difference between them and the pull-down transistor is substantially an N-channel metal oxide semiconductor field effect transistor (N-MOSFET), capable of being driven by a comparatively larger current, the discharging efficiency can be improved and thus the regulation can be achieved more rapidly, that is, Vₒᵤₜ can be sunk rapidly until it is equal to a ground voltage V_{SS}. Under normal operating conditions, the operational amplifier OP1 has a comparatively large gain while the V_{fb} is almost equal to the V_{ref}, that is, the whole circuit of the voltage regulator is capable of operating under a stable status and thus it is considered to be a voltage regulator with preferred electrical characteristics.

When an over-voltage condition exists due to the load current I_{load} of the regulator changing rapidly from a large value to near zero, the feedback voltage V_{fb} rises above Vₜᵣᵢₚ which drive the output voltage of the comparator C1 to rise while force the pull-down transistor MN_{O} to turn on so as to pull several milliamps of current from the output of the regulator, and return the output voltage of the regulator back into regulation in a matter of a few milliseconds.

Since the value of V_{fb} will be almost equal to that of V_{ref}, it is preferred to define the value of Vₜᵣᵢₚ as V_{ref}+ΔV, whereas ΔV, being a difference between the reference voltage V_{ref} and the bias voltage Vₜᵣᵢₚ, is defined to be 100 mV with respect to a preferred aspect of the invention. If the value of ΔV is set too large, the response time will be too long so that the pull-down transistor MN_{O} will not be activated until the output voltage of the comparator C1 reaches a high value to recovery the state. On the contrary, if the value of ΔV is set too small, the recovery is ease to be trigger erroneously by the affections of external noises.

From the above description with respect to those shown in FIG. 2, it is noted that the voltage regulator is characterized in that it is substantially a low dropout voltage regulator (LDO) having a comparator and a pull-down transistor, both being connected between the positive feedback input node of its operational amplifier (OP) and the ground, wherein the comparator is used for detecting the voltage variation of a reference node while the reference node is defined to be a node located between a first feedback resistor and a second feedback resistor; and the pull-down transistor, being substantially an N-channel metal oxide semiconductor field effect transistor (N-MOSFET), is forced to turn on so as to sink the output voltage rapidly for returning the same back into regulation as the voltage detected at the reference node is larger than a predetermined voltage.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A voltage regulator with output accelerated recovery circuit, characterized in that it is substantially a low dropout voltage regulator (LDO) having a comparator and a pull-down transistor, both being connected between the positive feedback input node of its operational amplifier (OP) and the ground end thereof, wherein the comparator is used for detecting the voltage variation of a reference node, while the reference node is defined to be a node located between a first feedback resistor and a second feedback resistor; and when the voltage detected at the reference node is larger than a predetermined voltage, the pull-down transistor is forced to turn on so as to sink the output voltage rapidly for returning the same back into regulation.

2. The voltage regulator of claim 1, wherein the pull-down transistor is substantially an N-channel metal oxide semiconductor field effect transistor (N-MOSFET).

3. The voltage regulator of claim 1, wherein the negative feedback node of the operational amplifier is electrically connected to a reference voltage.

4. The voltage regulator of claim 3, wherein the voltage of the negative feedback node of the operational amplifier is about the same as the voltage of the reference node.

5. A voltage regulator with output accelerated recovery circuit, comprising:
an operational amplifier, configured for receiving a feedback voltage at its positive feedback node while the feedback voltage is designed for reflecting the variation of an output voltage;
a comparator, electrically connected to the operational amplifier for comparing the feedback voltage with a biased voltage; and
a pull-down transistor, disposed between the comparator and the ground end while electrically connecting to the two;
wherein, the comparator capable of comparing the feedback voltage and the biased voltage so as to force the pull-down transistor to turn on and thus sink the output voltage rapidly for returning the same back into regulation.

6. The voltage regulator of claim 5, wherein the pull-down transistor is substantially an N-channel metal oxide semiconductor field effect transistor (N-MOSFET).

7. The voltage regulator of claim 5, wherein the biased voltage is equal to the sum of a tolerance value and a reference voltage.

8. The voltage regulator of claim 7, wherein the tolerance value is 100 mV.

9. The voltage regulator of claim 5, wherein the voltage of a negative feedback node of the operational amplifier is about equal to the feedback voltage.

10. The voltage regulator of claim 5, wherein a negative feedback node of the operational amplifier is electrically connected to a reference voltage.
